(19) United States
(12) Patent Application Publication
(10) Pub. No.: US 2010/0300375 A1
(43) Pub. Date: Dec. 2, 2010

(54) Dog leash grip handle having a storage means

(76) Inventor: Ue-Ming Yang, Chicago, IL (US)

Correspondence Address: UE-MINE YANG, 2712 S. UNION AVE., CHICAGO, IL, 60616, US

(21) Appl. No.: 12/454,861

(22) Filed: May 27, 2009

(51) Int. Cl. A01K 27/00

(52) U.S. Cl. 119/796; 119/795

(57) ABSTRACT

Present invention provides a container and means for locking and releasing container within a hollow grip handle in an extractable or non-extractable dog leash handle assembly. Container can also be converted to a plastic bag dispenser.

### BACKGROUND OF THE INVENTION

Present invention relates to a hollow grip handle in a dog leash handle assembly, having means for storing and retrieving objects such as plastic bags within the grip handle.

When a dog owner walks her or his dog in public street or park, she or he must lawfully leash dog and be responsible for picking up dog's droppings. Plastic waste bags are commonly used for this purpose. During walking a dog, dog owner may reluctantly carry plastic waste bag(s) by hand if she or he prefers to dress casually. Sometime, dog owner may forget to carry a plastic bag. Solving the above problems is the motive of present invention.

It becomes apparent that a simple solution to the above problems is to provide a means for storing plastic bag(s) within the dog leash handle assembly. There are two prior arts related to this approach. In US Patent Application Publication 2008/0006223, Eric Sugalski discloses a leash handle assembly that provides a storage compartment between the front section (i.e., leash connecting end) and the rear section (i.e., grip end) of the leash handle assembly. The most significant drawback of this prior art is that it is very difficult to retrieve the stored plastic bags when user is holding the grip end by hand during dog walking. In U.S. Pat. No. 7,044,080, Billy Rabello discloses a leash handle assembly, which provides a storage compartment in the hollow grip. There are two drawbacks in this prior art: (1). In Billy's first and second proposed embodiments, the opening of the storage compartment is at the lower end of grip. User needs to insert a finger into the storage compartment through the opening to retrieve the stored plastic bags. This is due to the elastic characteristic of plastic bags, which tends to keep plastic bags remained within the storage compartment. Retrieving the stored plastic bags can be a difficult task when user is holding the leash handle assembly during dog walking. User may not be able to retrieve the stored plastic bags if they are jammed within the storage compartment. This is particularly true for an elongated narrow grip. (2). In Billy's third embodiment, the opening is at the top end of grip. This embodiment is not suitable for use in an extractable leash handle assembly because operating mechanisms of the assembly occupy the top area of grip. The retrieving problems discussed in (1) above also exist in this embodiment.

In present invention, in lieu of storing plastic bags directly into the storage compartment of the hollow grip, plastic bags are stored in a container, which can be inserted into the storage compartment of hollow grip. In one embodiment of present invention, a spring biased locking and releasing means are provided for quick and easy insertion and removal of the container within hollow grip. User retrieves plastic bags from container when container is removed out of hollow grip. In another embodiment of present invention, user can retrieve plastic bags from container when container is retained within hollow grip, or removed out of hollow grip. In present invention, there are two measures to ensure that jammed plastic bags can always be retrieved out of container. One measure is to restrict the height of container within finger reach. Another measure is to provide a finger access opening at the closed end of container, so that user can insert a finger through the access opening to push the jammed plastic bags toward the open end of container. By adopting either one of the measures, user can always retrieve jammed plastic bags out of container. Also in present invention, container can be modified to a dispenser for storing and dispensing a roll of plastic bags.

### OBJECTS OF THE INVENTION

One object of present invention is to provide a container for storing objects such as plastic bags, and means for retaining, locking and releasing the container within the hollow grip handle of an extractable or non-extractable dog leash handle assembly.

Another object of present invention is to provide such a container that allows user to retrieve jammed plastic bags stored within the container.

Another object of present invention is to convert such a container to a dispenser for storing and dispensing a roll of plastic bags.

### BRIEF DESCRIPTION OF THE DRAWINGS

FIG. 1A is a perspective view of an extractable dog leash handle assembly that incorporates the first preferred embodiment of the hollow grip handle of present invention.

FIG. 1B is an exploded view of the grip handle of FIG. 1A

FIG. 2A is a perspective view of an extractable dog leash handle assembly that incorporates the second preferred embodiment of the hollow grip handle of present invention.

FIG. 2B is an exploded view of the grip handle of FIG. 2A

FIG. 3 is a perspective view of a non-extractable dog leash handle assembly that incorporates the first preferred embodiment of the hollow grip handle of present invention.

FIG. 4 is a perspective view of a non-extractable dog leash handle assembly that incorporates the second preferred embodiment of the hollow grip handle of present invention.

FIG. 5 shows a dispenser for storing and dispensing a roll of plastic bags, that is modified from the container in FIGS. 1A and 1B.

FIG. 6 shows a dispenser for storing and dispensing a roll of plastic bags, that is modified from the container in FIGS. 2A and 2B.

FIG. 7 shows another dispenser for storing and dispensing a roll of plastic bags, that is modified from the container in FIGS. 2A and 2B.

### DETAILED DESCRIPTION OF THE DRAWINGS

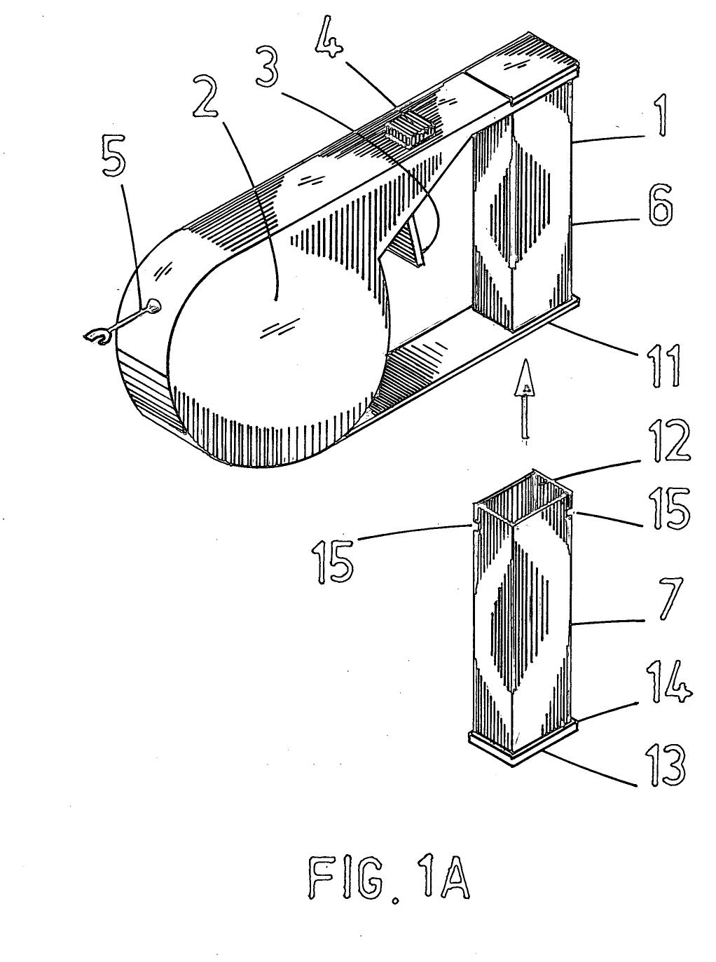

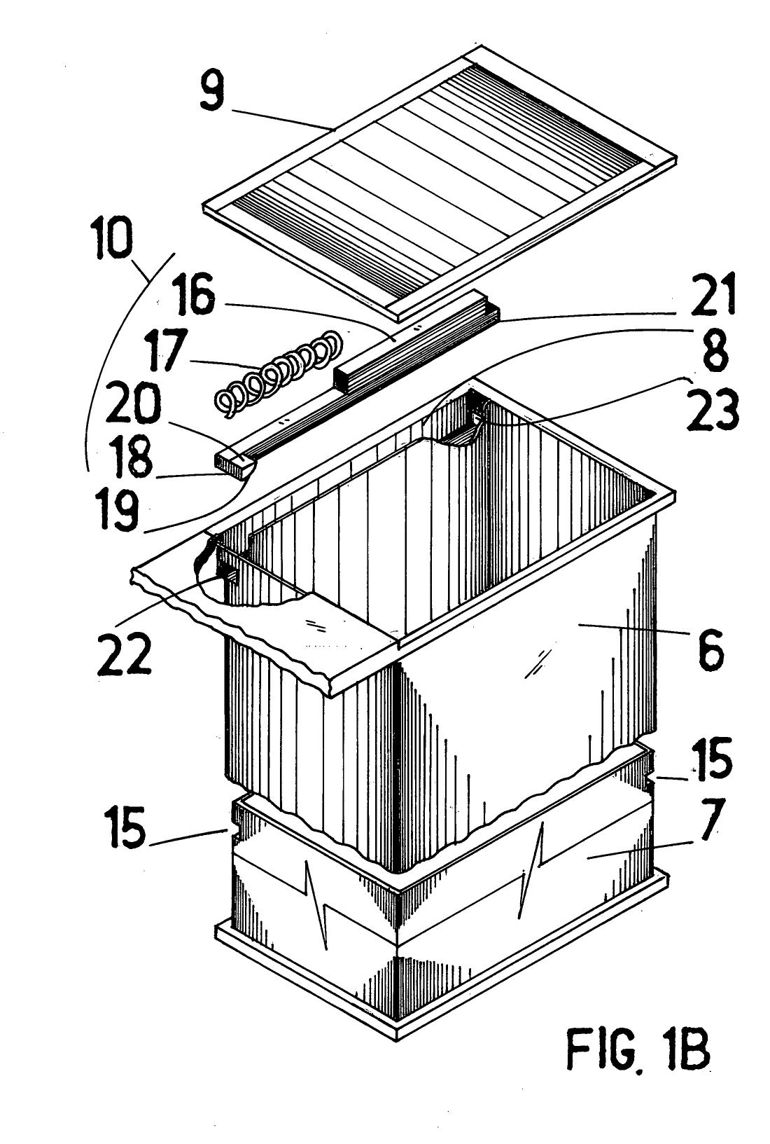

FIG. 1A is a perspective view of an extractable dog leash handle assembly that incorporates the first preferred embodiment of the hollow grip handle 1 of present invention. In FIG. 1A, the top and bottom ends of grip handle 1 are integrated and fixedly connected to the upper and lower parts of a hollow body 2 respectively, which contains operating mechanisms of the extractable leash handle assembly. For illustration purpose, a brake actuator 3, a brake lock 4, and a leash cord 5 extracted from the operating mechanism are shown in FIG. 1A. This is solely for purpose of illustrating the orientation of the extractable dog leash handle assembly. There are various orientations in prior art, which are different from that shown in FIG. 1A and are considered within the scope of present invention. FIG. 1B is an exploded view of the grip handle 1 of FIG. 1A.

In FIGS. 1A and 1B, grip handle 1 comprises of an elongated hollow bar 6 having a rectangular tubular cross section, an elongated container 7 having a rectangular tubular cross section, an integral housing 8 adjacent to the top end of hollow bar 6, a top cover plate 9, and a spring biased latching assembly 10 contained within housing 8. Top cover plate 9 is fixedly connected to the top end of hollow bar 6 by quick snap connectors (not shown). Container 7 is inserted into hollow bar 6 through the bottom open end 11, and slides freely within hollow bar 6 with negligible frictional force. Container 7 has a top open end 12, a bottom closed end 13, and an integral collar 14 projected laterally outward from the outer surface of container 7 at the bottom end 13. Collar 14 abuts bottom end 11 of hollow bar 6 when container 7 is completely inserted into hollow bar 6. Two corner cut-off receptacles 15 (in lieu of a single corner cut-off receptacle) for engaging with spring biased latching assembly 10 are provided at two diagonal corners of container 7 adjacent to top open end 12. As a result, there is no directional requirement during inserting container 7 into hollow bar 6.

The spring biased latching assembly 10 comprises of an elongated sliding rod 16 and a compression spring 17. A lateral projectile 18 is provided at one end of sliding rod 16, which has a profiled bottom surface 19 and a flat top surface 20. During assembling, projectile 18 and free end 21 of sliding rod 16 penetrate through openings 22 and 23 of housing 8 respectively. Free end 21 serves as an actuator of the spring biased latching assembly 10. Container 7 will be automatically locked and retained within hollow bar 6 when it is completely inserted into hollow bar 6. When hollow bar 6 is in upright position, container 7 will be released out of hollow bar 6 by gravity by pressing free end 21 of the sliding rod 16.

It is understood that techniques for a spring biased latching assembly are well known in prior art. The spring biased latching assembly 10 is not intended for limiting the scope of present invention. Modifications and variations to the spring biased latching assembly 10 are allowed and considered within the scope of present invention. It is also under stood that housing 8 and spring biased latching assembly 10 can be orientated differently so that the free end 21 of sliding rod 16 (i.e., actuator of the spring biased latching assembly 10) can be located at front, left or right side of hollow bar 6, in lieu of the rear side as shown in FIG. 1B.

In the above first preferred embodiment, an access opening (not shown) can be optionally provided at the bottom closed end 13 of container 7. When the stored object such as plastic bags are jammed within container 7, user can insert a finger through such an access opening to push the jammed plastic bags toward the top open end 12. As a result, jammed plastic bags can be removed out of container 7. If such an access opening is not provided at the bottom closed end 13, it is necessary to restrict the height of container 7 within finger reach. As a result, jammed plastic bags can be removed out of container 7.

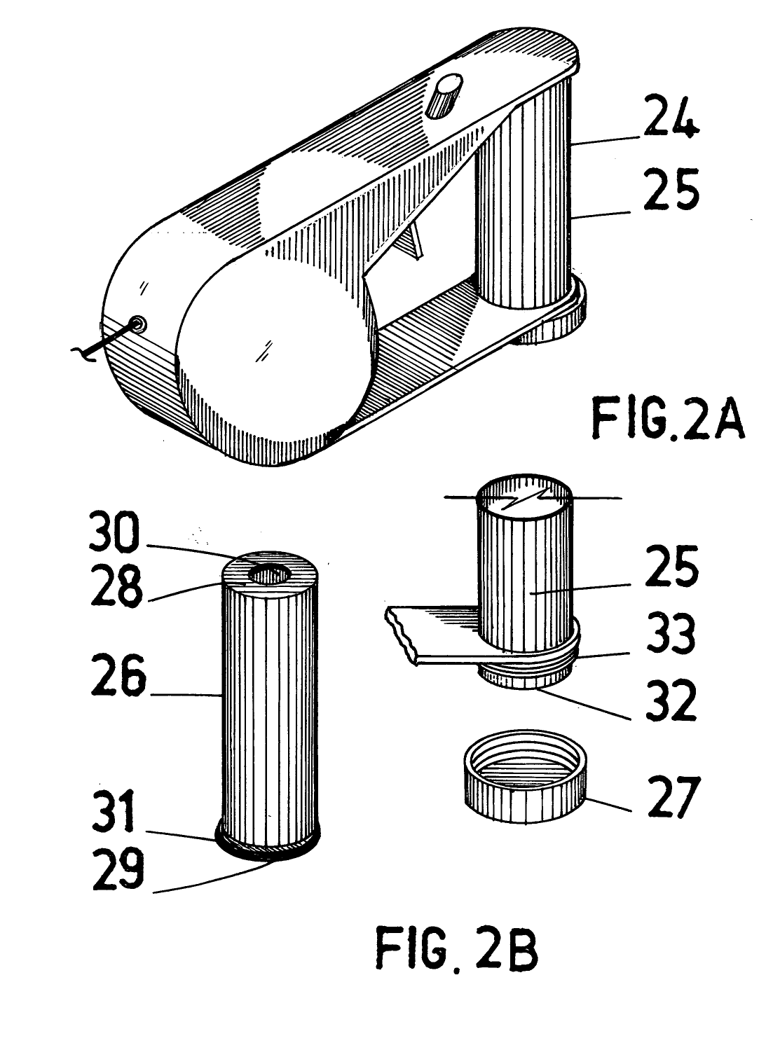

FIG. 2A is a perspective view of an extractable dog leash handle assembly that incorporates the second preferred embodiment of the hollow grip handle 24 of present invention. FIG. 2B is an exploded view of grip handle 24 of FIG. 2A. The grip handle 24 comprises of an elongated hollow bar 25 having a round tubular cross section, an elongated container 26 having a round tubular cross section, and an end closure 27. Container 26 has a top closed end 28 and a bottom open end 29. A finger access opening 30 is provided at the top closed end 28. Container 26 has an integral collar 31 projected laterally outward from the outer surface of container 26 at the bottom end 29, which abuts bottom open end 32 of hollow bar 25 when container 26 is completely inserted into hollow bar 25. Container 26 has a tight fit within hollow bar 25 so that external force must be applied at collar 31 in order to pull container 26 out of hollow bar 25. Hollow bar 25 has an integral collar 33 projected laterally outward from the outer surface of hollow bar 25 adjacent to but distanced with a clearance from bottom end 32. Such a clearance provides a finger access to collar 31 for pulling container 26 out of hollow bar 25. End closure 27 is detachably connected to collar 33 of hollow bar 25 to conceal bottom ends 29 and 32 of container 26 and hollow bar 25 respectively. Preferably, exterior and interior threads are provided at collar 33 and end closure 27 respectively for thread engagement.

In the second preferred embodiment, user can retrieve the stored objects such as plastic bags from container 26 when container 26 is retained within hollow bar 25. When plastic bags are jammed within container 26, user can remove container 26 out of the hollow bar 25, and insert a finger through access opening 30 to push the jammed plastic bags toward the open end 29. As a result, jammed plastic bags can be removed out of container 26.

It is understood that the first and second preferred embodiments in FIGS. 1A, 1B, 2A and 2B are shown for use in the extractable dog leash handle assembly. It becomes apparent that they can also be used in the non-extractable dog leash assemblies, which are represented in FIGS. 3 and 4. FIG. 3 and FIG. 4 are identical to FIG. 1A and FIG. 2A respectively with exception that the hollow body 2 for housing the operating mechanisms of the extractable dog leash assemblies is now replaced by extension arms 34 and 35 in FIGS. 3 and 4 respectively. Rather than integrally connecting extension arms 34 and 35 to both top and bottom ends of grip handle as shown in FIGS. 3 and 4 respectively, extension arms 34 and 35 can be alternatively connected to the top end of grip handle only (not shown).

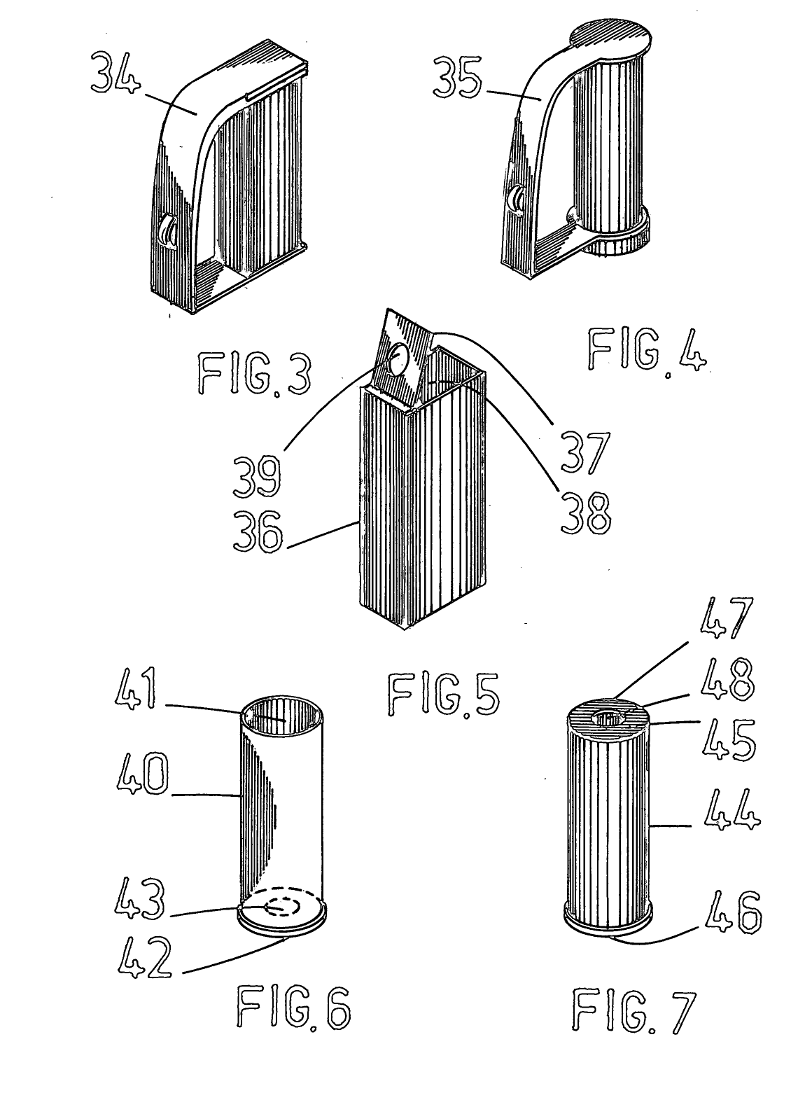

One object of present invention is to convert the container to a dispenser for storing and dispensing a roll of plastic bags. FIG. 5 shows a dispenser 36 that is modified from container 7 of the first preferred embodiment (FIGS. 1A and 1B). Dispenser 36 has a hinged door 37 at the top end 38. Door 37 has an opening 39 for dispensing a roll of plastic bags (not shown) when door 37 is closed. A latch or snap connector (not shown) can be used as a means locking door 37 at closed position. FIG. 6 shows a dispenser 40 that is modified from container 26 of the second preferred embodiment (FIGS. 2A and 2B). Dispenser 40 has a top open end 41, and a close bottom end 42 with an opening 43. It is understood that container 26 is fit tightly and retained within hollow bar 25 (FIG. 2B) by frictional force. However, dispenser 40 is suggested to be fixedly retained within hollow bar 25 (for example) through thread engagement (not shown). When dispenser 40 is fixedly connected within hollow bar 24, opening 43 provides a means for dispensing plastic bags. FIG. 7 shows another dispenser 44 that is modified from container 26. Dispenser 44 has a top open end 45 and a closed bottom end 46. An internal screw cap 47 is fixedly connected the top open end 45 through thread engagement (not shown). Opening 48 is provided at screw cap 47. Dispenser 44 fits and slides freely within hollow bar 25. When dispenser 44 is removed out of the hollow bar 25, opening 47 provides a means for dispensing plastic bags.

It is understood that modifications and variations to hollow bar or container of present invention, such as changing the shape hollow bar or container, or converting container to various forms of a dispenser, shall be considered within the scope of present invention.

What is claimed is:

1. A grip handle of an extractable dog leash handle assembly comprising of:
an elongated hollow bar having a top and bottom ends,
a means for integrating and fixedly connecting said top and bottom ends of said hollow bar to an upper and lower parts of a hollow body respectively,
an elongated container having a top and bottom ends, capable of being inserted into said hollow bar by entering said top end of said container through said bottom end of said hollow bar,
a locking means for locking and retaining said container within said hollow bar, and
a releasing means for releasing said locking means and releasing said container out of said hollow bar through said bottom end of said hollow bar;
wherein:
said hollow bar and said hollow body forms an integral housing that contains operating mechanisms of said extractable dog leash handle assembly.

2. The grip handle according to claim 1, in which:
said top and bottom ends of said container are open and closed ends respectively; and
a spring biased latch is provided adjacent to said top end of said hollow bar; and
at least a receptacle is provided in the outer surface of said container adjacent to said top end of said container, so that said spring-biased latch automatically engages with said receptacle to lock and retain said container within said hollow bar when said container being completely inserted into said hollow bar; and
said receptacle is disengaged from said spring biased latch to release said container out of said hollow bar when a release button of said spring biased latch is pressed.

3. The grip handle according to claim 1, in which:
said container has an open end and a closed end; and
said container has an integral circumferential collar projected laterally outward from the outer surface of said container at said bottom end of said container, and said collar abuts said bottom end of said hollow bar when said container is completely inserted into said hollow bar; and
said hollow bar has an integral circumferential collar projected laterally outward from the outer surface of said hollow bar adjacent to but distanced with a clearance from said bottom end of said hollow bar; and
an end closure and a means are provided for detachably connecting said end closure to said collar of said hollow bar to conceal said bottom ends of said container and said hollow bar.

4. The grip handle according to claims 1 and 3, in which, said end closure and said collar of said hollow bar are provided with interior and exterior threads respectively for thread engagement.

5. A grip handle of a non-extractable dog leash handle assembly comprising of:
an elongated hollow bar having a top and bottom ends,
a means for integrating and fixedly connecting at least one end of said hollow bar to an extension arm,
a means for detachably connecting a leash to said extension arm,
an elongated container having a top and bottom ends, capable of being inserted into said hollow bar by entering said top end of said container through said bottom end of said hollow bar,
a locking means for locking and retaining said container within said hollow bar, and
a releasing means for releasing said locking means and releasing said container out of said hollow bar through said bottom end of said hollow bar.

6. The grip handle according to claim 5, in which:
said top and bottom ends of said container are open and closed ends respectively; and
a spring biased latch is provided in said hollow bar; and
at least a receptacle is provided in the outer surface of said container, so that said spring-biased latch automatically engages with said receptacle to lock and retain said container within said hollow bar when said container being completely inserted into said hollow bar; and
said receptacle is disengaged from said spring biased latch to release said container out of said hollow bar when a release button of said spring biased latch is pressed.

7. The grip handle according to claim 5, in which:
said container has an open and closed ends, and
said container has an integral circumferential collar projected laterally outward from the outer surface of said container at said bottom end of said container, and said collar abuts said bottom end of said hollow bar when said container is completely inserted into said hollow bar; and
said hollow bar has an integral circumferential collar projected laterally outward from the outer surface of said hollow bar adjacent to but distanced with a clearance from said bottom end of said hollow bar; and
an end closure and a means are provided for detachably connecting said end closure to said collar of said hollow bar to conceal said bottom ends of said container and said hollow bar within said enclosure.

8. The grip handle according to claims 5 and 7, in which, said end closure and said collar of said hollow bar are provided with interior and exterior threads respectively for thread engagement.

9. The container according to claim 2, in which, said top open end has an end closure to close said top open end, and said closure has an opening for dispensing plastic bags stored within said container.

10. The container according to claim 3, in which, said open and closed ends of said container are at said bottom and top ends of said container respectively, and said closed top end has a finger access opening.

11. The container according to claim 3, in which, said open and closed ends of said container are at said top and bottom ends of said container respectively, and said closed bottom end has an opening for dispensing plastic bags stored within said container.

12. The container according to claim 3, in which, said open and closed ends of said container are at said top and bottom ends of said container respectively, and said top open end has a detachable end closure with an opening for dispensing plastic bags stored within said container.

13. The container according to claim 6, in which, said top open end has an end closure to close said top open end, and said closure has an opening for dispensing plastic bags stored within said container.

14. The container according to claim 7, in which, said open and closed ends of said container are at said bottom and top ends of said container respectively, and said closed top end has a finger access opening.

15. The container according to claim 7, in which, said open and closed ends of said container are at said top and bottom ends of said container respectively, and said closed bottom end has an opening for dispensing plastic bags stored within said container.

16. The container according to claim 7, in which, said open and closed ends of said container are at said top and bottom ends of said container respectively, and said top open end has a detachable end closure with an opening for dispensing plastic bags stored within said container.
